(19) United States
(12) Patent Application Publication
(10) Pub. No.: US 2010/0299281 A1
(43) Pub. Date: Nov. 25, 2010

(54) Facilitating management of 401K retirement savings plans

(76) Inventors: Eric S. Smith, Waterford, MI (US); Joseph Simko, Sterling Heights, MI (US)

Correspondence Address: Galasso & Associates , L.P., P.O.Box 26503, Austin, TX, 78755-0503, US

(21) Appl. No.: 12/660,521

(22) Filed: Feb. 26, 2010

Related U.S. Application Data
(63) Continuation of application No. 11/497,548, filed on Aug. 1, 2006, now abandoned.

(51) Int. Cl. G06Q 40/00

(52) U.S. Cl. 705/36 R

(57) ABSTRACT

A consultation analysis for a 401K retirement savings plan comprises a plurality of informational elements. Participant profiles are a first one of the informational elements and are provided for each one of a plurality of classes of participants in the 401K retirement savings plan. A model portfolio is a second one of the informational elements and are provided for each one of the participant profiles. At least a portion of the model portfolios include a plurality of asset classes. Designation of a plurality of performance-quantified investment choices for each one of the asset classes is a third informational element. The performance quantified investment choices are performance-quantified with respect to at least one performance factor. Designation of a plurality of suggested ones of the investment choices for each one of the asset classes is a fourth informational element.

### CROSS REFERENCE TO RELATED APPLICATIONS

This continuation patent application claims priority from co-pending United States non-provisional continuation-in-part patent application having Ser. No. 11/497,548; filed Aug. 1, 2006; entitled “FACILITATING MANAGEMENT OF 401K RETIREMENT SAVINGS PLANS”, which claims priority from co-pending United States non-provisional patent application entitled “DECISION ASSISTANCE PLATFORM CONFIGURED FOR FACILITATING FINANCIAL CONSULTING SERVICES” having Ser. No. 10/923,659 and being filed on Aug. 20, 2004, from co-pending United States non-provisional patent application entitled “DECISION ASSISTANCE PLATFORM CONFIGURED FOR FACILITATING FINANCIAL CONSULTING SERVICES” having Ser. No. 10/923,512 and being filed Aug. 20, 2004, and from co-pending United States non-provisional patent application entitled “SYSTEM AND METHOD CONFIGURED FOR FACILITATING FINANCIAL ANALYSIS” having Ser. No. 10/923,658 and being filed Aug. 20, 2004, all of which have a common applicant herewith and are being incorporated herein in their entirety by reference.

### FIELD OF THE DISCLOSURE

The inventive disclosures made herein relate generally to financial consulting methodologies and more particularly to systems, analysis information and methods configured for facilitating management of 401K retirement savings plans.

### BACKGROUND

Many financial experts and investors would agree that there has been a considerable increase in the lack of investor trust within the traditional financial services industry. Circumstances responsible for this lack of trust include the undisclosed offering of financial incentive to induce the preferential recommendation of particular products, poor advice from financial advisors, advice based on flawed and/or inaccurate information, predatory sales tactics, and corrupt financial organization. The circumstances that have led to this lack of trust have contributed to a general market decline (i.e., value of funds and number of persons investing), which is a circumstance quite damaging to the equity markets and the ability of companies to raise capital (as well as damaging to a transaction and product sales-based industry—the traditional financial industry).

Product vendors and their paid salespeople generally control and often limit access to product information. Vendors typically do not want consumers of such financial products to have a practical way to objectively evaluate their products in comparison with those of others. Such an ability to objectively compare (i.e., comparatively evaluate) products being to offered would effectively commoditize financial products, and would adversely impact the hoped for effect of the large advertising and marketing budgets of these large product vendors. Guarding against the risk that industry products such as mutual funds are not turned into commodities was listed as one of top challenges facing the Investment Company Institute's membership, as was stated in the Jun. 20, 2000 Financial Planning Journal of the Bureau of National Affairs.

Brokers and other product salespeople from the traditional financial services industry continually approach prospective and active individual investors (i.e., consumers) to solicit the consumer to buy their financial products. In general, these brokers and salespeople are approaching the consumers not necessarily because their financial products are needed or have been requested, but because that is their job. They have been hired to sell a particular organization's financial products to whomever they can.

Over the past 15 or more years, there has been a general trend within the financial services marketplace away from individual advice and guidance toward product sales. This can be envisioned in what can be described as a customer—client continuum, where at one end (i.e., the customer side) of the continuum a person is treated as a customer to be sold and, at the other end (i.e., the client side), the person is treated as a client to be advised. This trend toward the “customer” side of the continuum is leaving an increasingly large void at the “client” side of the continuum.

In an environment with ever-growing numbers of financial products (e.g., over 17,000 mutual funds and thousands of insurance products), consumers have no practical approach for obtaining information on all of these choices and no practical approach for comparatively evaluating them (e.g., to see which would be best for them) even if they could obtain the needed information. This lack of knowledge is often exploited by the traditional financial services industry. Because trusted advisers of consumers (e.g., attorneys and Certified Public Accountants) also lack sufficient knowledge of and information about these many financial products, even these trusted advisors are often limited in what they can do to protect their clients from having this lack of product knowledge exploited. This limitation often holds true even if they are able to obtain such information, because of the overwhelming volume of such information.

Yet another limitation of such conventional financial products and services is that related conventional processes used to select and recommend money managers are essentially “opaque”. Such processes (if they in fact exist) are typically not disclosed and the investors and fiduciaries (of various investing entities, such as retirement plans, trusts, endowments, etc.) to whom such product and services are being offered rarely (if ever) request a description or explanation of the means by which (i.e., “how” and “why”) these products or services (e.g. mutual funds, money managers, etc.) are selected and/or why they are being recommended. With this process being essentially opaque, any number of abuses can occur with limited means for readily detecting them.

In the case of a 401K retirement savings plan, a trustee entity of the 401K retirement savings plan is a trusted advisor with respect to company employees who are participants within the company's 401K retirement savings plan. Accordingly, the plan participants are the consumers of the financial products offered via the 401K retirement savings plan. The company's trustee entity of the 401K retirement savings plan represent the plan participants' trusted advisor in that the trustee entity, as a representative of the plan participants' company, is presumed to serve the best interest of the plan participants when determining which investment choice options to make available to the plan participants. Additionally, through determining which investment choice options to make available to the plan participants, the trustee entity also serves to insulate the plan participants from sales pressures typically inherent in the traditional financial services industry (and incentive-based compensation structures that have largely corrupted the “advisory” process). These expectations of the plan trustee are lead many company employees to participant in their company's 401K retirement savings plan rather than investing through other avenues (e.g., directly with vendors of financial products). Therefore, methods, analysis information and equipment configured for facilitating management of 401K retirement savings plans in a manner that overcomes limitations and shortcomings of conventional approaches for facilitating management of 401K retirement savings plans would be advantageous, desirable and useful.

### SUMMARY OF THE DISCLOSURE

In one embodiment of the inventive disclosures made herein, a method for facilitating management of a 401K retirement savings plan comprises preparing template information for a 401K retirement savings plan and determining a plurality of performance-quantified investment choices. The template information is dependent upon a class of participant in the 401K retirement savings plan and includes performance criteria, weightings, defined investment dataset information, filters configured for refining investment dataset information and/or process instructions. The plurality of performance-quantified investment choices are determined for asset classes of a model portfolio for the class of participant and are determined dependent upon at least a portion of the template information.

In another embodiment of the inventive disclosures made herein, a method for facilitating management of a 401K retirement savings plan comprises preparing template information for a 401K retirement savings plan, determining a participant profile corresponding to a class of participant in the 401K retirement savings plan, determining a model portfolio for the participant profile and determining a plurality of performance-quantified investment choices for each one of the asset classes. The template information includes at least one of asset class performance criteria, weightings, defined investment dataset information, filters configured for refining investment dataset information and process instructions. The model portfolio includes a plurality of asset classes and a respective percent allocation of each one of the asset classes is dependent upon the asset class performance criteria. Determining the plurality of performance-quantified investment choices is performed dependent upon at least a portion of the template information.

In another embodiment of the inventive disclosures made herein, a consultation analysis for a 401K retirement savings plan comprises a plurality of informational elements. Participant profiles are a first one of the informational elements and are provided for each one of a plurality of classes of participants in the 401K retirement savings plan. A model portfolio is a second one of the informational elements and are provided for each one of the participant profiles. At least a portion of the model portfolios include a plurality of asset classes. Designation of a plurality of performance-quantified investment choices for each one of the asset classes is a third informational element. The performance quantified investment choices are performance-quantified with respect to at least one performance factor. Designation of a plurality of suggested ones of the investment choices for each one of the asset classes is a fourth informational element.

Correspondingly, it is a principal object of the inventive disclosures made herein to provide a solution that overcomes limitations and drawbacks associated with conventional approaches for facilitating financial services for clients. Specifically, methods disclosed herein enable facilitation of financial consulting services via a trusted adviser of the client, to but who is not necessarily a professional within the traditional financial services industry.

Furthermore, such methods produce consulting information (e.g., investment choices) that is objectively quantified. Accordingly, embodiments of methods in accordance with the inventive disclosures made herein enable a client to make decisions in an objective and unbiased manner.

Turning now to specific embodiments of the inventive disclosures made herein, in at least one embodiment of the inventive disclosures made herein, performance criteria include parameters designating a desired performance effect of an investment for the client and preparing client-specific template information includes quantitatively and/or qualitatively representing the performance criteria.

In at least one embodiment of the inventive disclosures made herein, determining client-specific consulting information includes creating a hierarchical weighting structure having a plurality of parent class nodes and a performance factor and/or a child class node associated with one or more of the parent class nodes, and distributing weightings to each performance factor and/or class node.

In at least one embodiment of the inventive disclosures made herein, distributing weightings includes assigning relative weightings and calculating actual weightings dependent upon information derived from the relative weightings.

In at least one embodiment of the inventive disclosures made herein, each one of a plurality of parent class nodes comprises a plurality of performance factors and/or a combination of one or more performance factor and one or more child class node.

In at least one embodiment of the inventive disclosures made herein, providing client-specific consulting information includes outputting client-specific consulting information, displaying the client-specific consulting information, and/or enabling access to the client-specific consulting information for the purpose of determining related information.

In at least one embodiment of the inventive disclosures made herein, determining client-specific consulting information includes determining client-specific investment choices to dependent upon information derived from performance criteria, and objectively quantifying investment choices dependent upon information derived from the performance criteria thereby generating objectively quantified investment choices.

In at least one embodiment of the inventive disclosures made herein, determining client-specific consulting information and/or objectively quantifying investment choices includes determining a collection of investment indices that are each dependent upon information derived from a respective investment within an investment portfolio, and determining composite investment index performance score dependent upon information derived from the indices.

In at least one embodiment of the inventive disclosures made herein, determining client-specific consulting information and/or objectively quantifying investment choices includes determining an asset class corresponding to an allocated investment within an investment portfolio and performing a comparative performance assessment between the allocated investment and a plurality of non-allocated ones of the performance-quantified investment choices represented within the asset class.

In at least one embodiment of the inventive disclosures made herein, determining client-specific consulting information and/or objectively quantifying investment choices includes determining a plurality of investment performance scores that correspond to a respective investment within an investment portfolio and determining a plurality of investment index performance scores that each correspond to a respective investment index.

In at least one embodiment of the inventive disclosures made herein, determining client-specific consulting information and/or objectively quantifying investment choices includes determining a composite performance score dependent upon information derived from investment performance scores and determining a composite investment index performance score dependent upon information derived from investment index performance scores.

In at least one embodiment of the inventive disclosures made herein, determining the composite performance score and determining the composite investment index performance score are each determined dependent upon intended assert allocation as opposed to current asset allocation.

In at least one embodiment of the inventive disclosures made herein, preparing client-specific template information includes specifying information that defines performance criteria, weightings, defined investment dataset information, filters configured for refining investment dataset information, and/or process instructions.

In at least one embodiment of the inventive disclosures made herein, performance criteria include parameters designating a desired performance effect of an investment and preparing client-specific template information includes quantitatively and/or qualitatively representing the performance criteria.

In at least one embodiment of the inventive disclosures made herein, a consultation analysis includes an asset class graphic representation depicting each one of the asset classes relative to a degree of risk and a degree of return.

In at least one embodiment of the inventive disclosures made herein, each one of the model portfolios is depicted in comparison with all other model portfolios with the corresponding asset class blends for each of the model portfolios, relative to the degree of risk.

In at least one embodiment of the inventive disclosures made herein, a consultation analysis includes designation of at least one allocated investment of the 401K retirement savings plan in at least one of the asset classes.

In at least one embodiment of the inventive disclosures made herein, performance of each allocated investment of the 401K retirement savings plan is quantified relative to the performance-quantified investment choices for the corresponding asset classes.

In at least one embodiment of the inventive disclosures made herein, a consultation analysis includes a performance score comparison for each one of the asset classes.

In at least one embodiment of the inventive disclosures made herein, the performance score comparison depicts relative performance of the performance-quantified investment choices.

In at least one embodiment of the inventive disclosures made herein, the performance score comparison depicts relative performance of each allocated investment of the 401K retirement savings plan.

In at least one embodiment of the inventive disclosures made herein, the performance-quantified investment choices are quantified with respect to corresponding degrees of risk and return.

In at least one embodiment of the inventive disclosures made herein, weightings applied to performance criteria corresponding to quantifying risk and return are depicted in a consultation analysis.

In at least one embodiment of the inventive disclosures made herein, the performance-quantified investment choices are each quantified with respect to a respective performance score.

In at least one embodiment of the inventive disclosures made herein, the performance-quantified investment choices for at least one of the asset classes are depicted relative to a plurality of different corresponding degrees of risk and return.

These and other objects and embodiments of the inventive disclosures made herein will become readily apparent upon further review.

### BRIEF DESCRIPTION OF THE DRAWING FIGURES

FIG. 1 depicts an information flow schematic in accordance with an embodiment of the inventive disclosures made herein.

FIGS. 2A and 2B depict a method for facilitating financial consulting services in accordance with embodiments of the disclosures herein and in view of the information flow schematic depicted in FIG. 1.

FIG. 3 depicts an embodiment of the operation for determining the investment choices depicted in FIG. 2.

FIG. 4 depicts an embodiment of the operation for enabling the comparative to performance assessment of the investment portfolio depicted in FIG. 2.

FIG. 5 is a chart depicting a graphical representation of performance scores in accordance with an embodiment of the inventive disclosures made herein.

FIGS. 6A and 6B jointly depict an alternate embodiment for presenting the information depicted in the chart of FIG. 5.

FIG. 7A depicts a table having a plurality of multi-segment bars that graphically represent performance information for performance-quantified investment choices.

FIG. 7B depicts a table comprised by tabular data representing performance information for performance-quantified investment choices.

FIG. 7C depicts a composite performance score distribution graph for the investment choices depicted in the table of FIG. 7B

FIG. 8A depicts an embodiment of a weighting approach configured for facilitating a comparative performance assessment in accordance with the inventive disclosures made herein

FIGS. 8B and 8C depict an embodiment of a hierarchical weightings structure in accordance with the inventive disclosures made herein.

FIG. 9A depicts asset class allocation for each of the participant profiles presented herein in Table 2.

FIG. 9B depicts an asset class structure that depicts each one of the asset classes of FIG. 9A relative to a degree of risk and a degree of return.

to FIG. 9C depicts an embodiment of a weighting and performance criteria structure for enabling analysis of multiple scenarios of an asset class in accordance with the inventive disclosures made herein.

FIG. 10 depicts a network system configured for facilitating financial consulting services functionality in accordance with embodiments of the inventive disclosures made herein.

### DETAILED DESCRIPTION OF THE DRAWING FIGURES

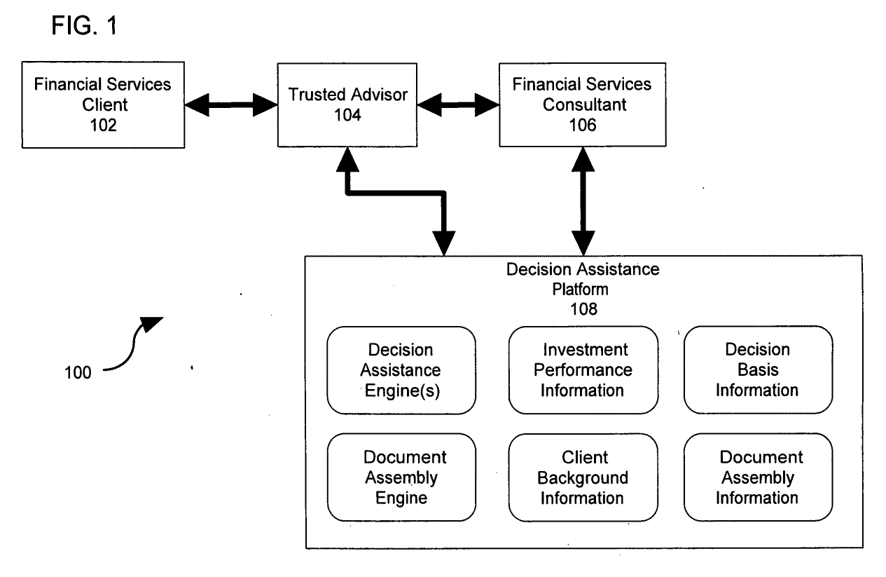

An embodiment of an information flow schematic 100 in accordance with the inventive disclosures made herein is depicted in FIG. 1. Entities within the information flow schematic include a financial services client 102, a trusted advisor 104 (i.e., an affiliated trusted advisor), a financial services consultant 106 and a decision assistance platform 108 (i.e., a system). Communication of information (e.g., client background information and/or client-specific consulting information) is carried out between the financial services client 102 and the trusted advisor 104. Similarly, communication of information (e.g., client background information and/or client-specific consulting information) is carried out between the trusted advisor 104, the financial service consultant 106 and the decision assistance platform 108.

In the embodiment of the information flow schematic 100 depicted in FIG. 1, the trusted advisor 104 is a separate person/entity from the financial services consultant 106 and isolates the financial services client 102 from direct interaction with the financial services consultant 106 and the decision assistance platform 108. In another embodiment (not specifically shown), the trusted advisor 104 and the financial services consultant are the same person (e.g., an attorney, CPA or family member), whereby that same person isolates the financial services client 102 from in-depth and/or direct interaction with the decision assistance platform 108. In still another embodiment (not specifically shown), the trusted advisor 104 and the financial services consultant are different persons acting on behalf of the financial services client 102 from within a common organization (e.g., an attorney and CPA employed by a common local, national or international consulting firm), whereby the common organization isolates the financial services client 102 from in-depth and/or direct interaction with the decision assistance platform 108. In yet another embodiment (not specifically shown), the financial services client 102 serves as his or her own trusted advisor and financial services consultant, whereby the financial services client 102 directly interacts with the decision assistance platform 108.

In an embodiment of the inventive disclosures made herein, the financial services in relate to a 401K retirement savings plan of a company. In such an embodiment, the trusted advisor 104 is a trustee entity (i.e., one or more persons and/or a business enterprise) of the company's 401K retirement savings plan and/or a designated representative of the trustee and the financial services client 102 is an employee of the company who is a participant in the company's 401K retirement savings plan.

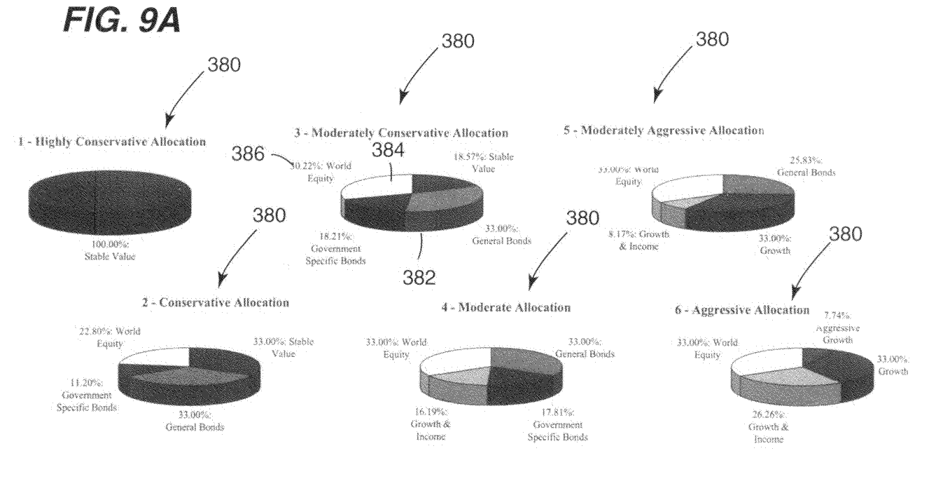

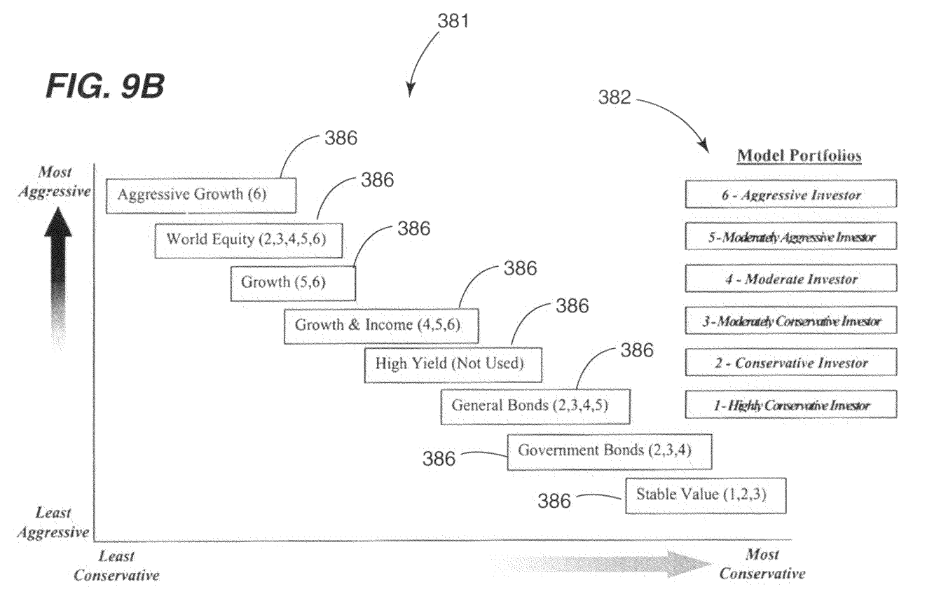

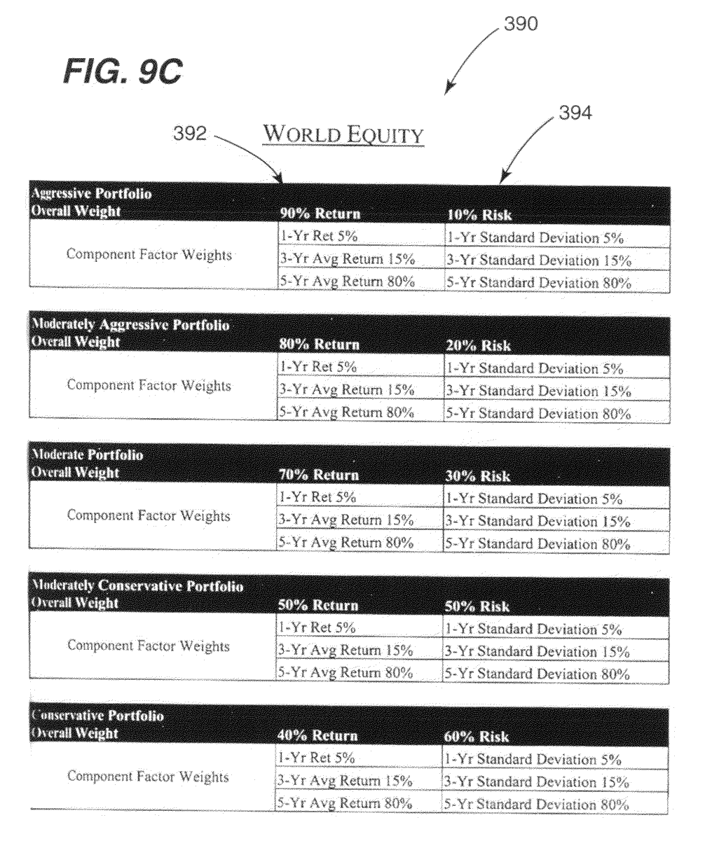

It is disclosed herein that interaction and communication between the financial services client 102, the trusted advisor 104 (i.e., an affiliated trusted advisor), the financial services consultant 106 and/or the decision assistance platform 108 may be implemented via a networked computer systems. For example, via the network system 400 depicted in FIG. 9, such interaction and communication may be facilitated via a networked computer system.

The Internet is one embodiment of such a networked computer system. As such, it is disclosed herein that a website may be provided for enabling such interaction and communication. Specific examples of such interaction and communication include, information acquisition functionality (e.g., receiving background information from the client), service payment functionality (electronically receiving payment for services), distributed processing functionality (e.g., where various decision assistance functionality is performed in a distributed manner), consulting information delivery functionality (e.g., providing client-specific consulting information such as objectively-quantified investment choices and client-specific reports to the client and/or trusted advisor), etc.

The decision-assistance platform 108 accesses and/or is provided information about, for example, the client (e.g., the client's life circumstances, investment preferences, financial position, financial goals, risk tolerances, etc.), decision basis information (including, without limitation, asset allocation technology and rule set), investment performance information (both with regard to all available product choices and client-specific, historic performance information) and document format template information for performing associated decision assistance functionality. In one embodiment, information utilized in carrying out decision assistance functionality as disclosed herein (e.g., manually and/or by a decision assistance platform) is stored in and accessible from one or more databases. Examples of decision assistance functionality, as discussed below in greater detail, include inputting, compiling and/or determining information comprised by a client-specific template and determining client-specific consulting information (e.g., determining client-specific investment choices) at least partially dependent upon decision basis information. Examples of such decision basis information include information relating to prescribed decision-making rules, information relating to investment effect selection and information relating to correlating investments opportunities to client financial needs, desires and/or goals. Examples of investment performance information include information associated with returns on an investment, information associated with risk of an investment, information associated with other performance and structural characteristics of an investment (e.g., manager tenure, turnover ratio, internal fee/cost structures, etc.) and information associated with compiling comparative analyses of performance and structural data. Examples of document format information include information associated with formatting prescribed documents, content included within prescribed documents and information associated with outputting information related to making investment choices (e.g., creating a printed document including such information and/or displaying such information). Decision basis information, investment performance information, and document format information are examples of client-specific consulting information in view of a particular client and facilitating decision assistance functionality in accordance with the inventive disclosures made herein.

In accordance with at least one embodiment of the inventive disclosures made herein, decision assistance functionality disclosed herein is carried out by a decision assistance platform that comprises a first decision engine (e.g., a rules-based expert system) and a second decision engine (e.g., a investment selection optimization system). The first decision engine facilitates creation of a client-specific template that represents a client-specific profile comprising various information (e.g., rules, data sets, processing instructions, performance criteria, etc). Examples of such information comprised by the client-specific template include performance weightings and factors (e.g., parameters corresponding to investment effects desired by the client), defined data and/or datasets, logic conditional filters for designating manipulation (e.g., refining/slimming datasets) of datasets, and processing instructions. The processing instructions represent information that enables tasks such as proper utilization of factors, weightings and filters to be facilitated, that enables document assembly functionality to be facilitated (e.g., automated report generation) and information related to recursive analysis/assessment of investment information. Information comprised by the client-specific template is utilized by the second decision engine to facilitate scoring and ranking processes for optimizing investment selection (i.e., generating investment choices) in a manner consistent with a client's individual needs, goals and desires. Such instructions include information relating to appropriate percentage allocation of investments among available asset classes (i.e., the asset allocation), to appropriate blending of performance factors and/or to appropriate weighting of such factors. The scoring and ranking processes includes enabling assessment of investment choices in a manner that is intended to aid a client in identifying which money management teams have historic performance that most closely matches the investment experiences that the client desires (i.e., what investment effect the client desires).

It is disclosed herein that a person may perform, in a manual fashion, certain decision assistance functionality disclosed herein as being facilitated by the decision assistance platform rather than such functionality being performed by the decision assistance platform. In one example, functionality of disclosed herein as being facilitated by the first decision engine of the decision assistance platform is at least partially facilitated by a person in a manual manner and resulting information is subsequently made available to the decision assistance platform for enabling functionality of the decision assistance platform to be facilitated (e.g., functionality facilitated by the second decision engine of the decision assistance platform). In one specific example, client-specific template information is at least partially generated in a manual manner rather than by a decision engine of the decision assistance platform

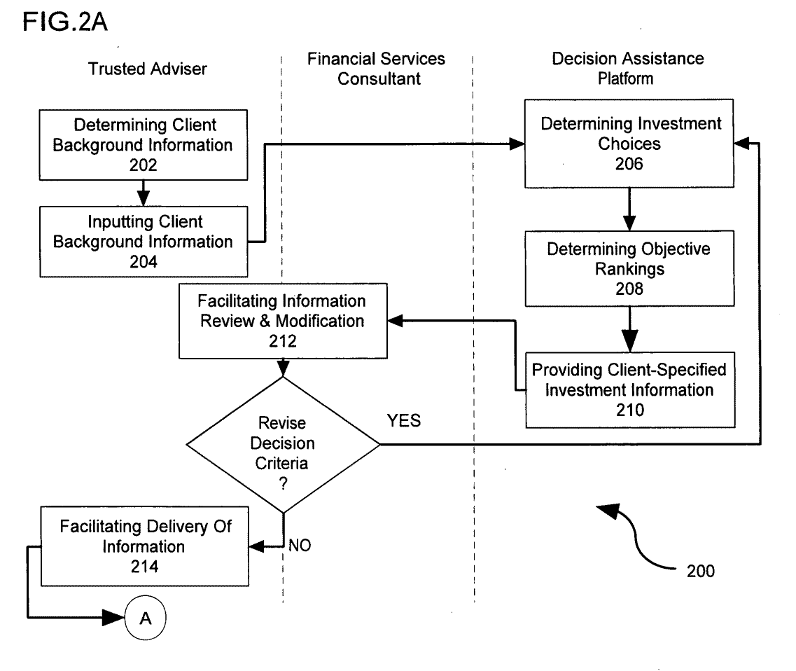

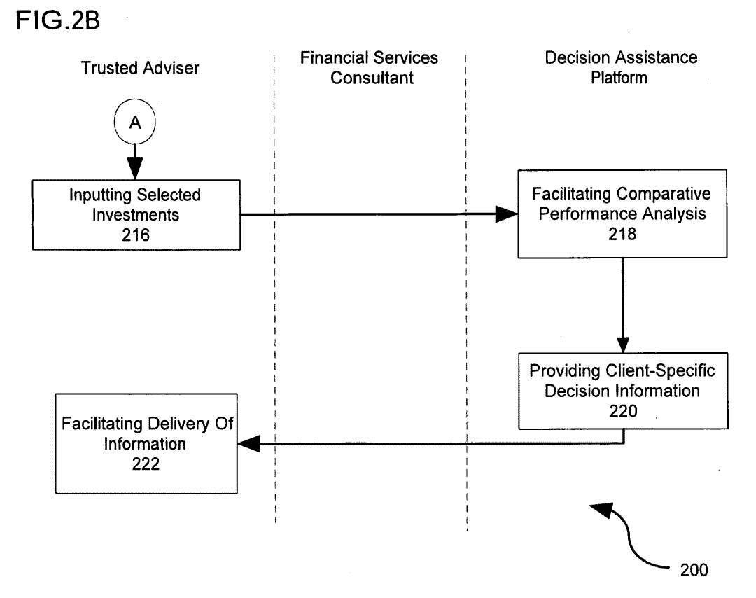

FIGS. 2A and 2B depict a method 200 for facilitating financial consulting services in accordance with embodiments of the disclosures herein and in view of the information flow schematic 100 depicted in FIG. 1. An operation 202 is performed for obtaining client background information, such as in response to a meeting with the financial services client. After obtaining the client background information, an operation 204 is performed for inputting relevant and/or required client background information into a decision assistance platform. Inputting such information is an embodiment of enabling access of such information.

In response to inputting the client financial objectives, the decision assistance platform performs an operation 206 for determining investment choices (e.g., an appropriate asset allocation) that correspond to the client financial objectives. After determining the investment choices (e.g., asset allocation), the decision-assistance platform performs an operation 208 for determining an objective ranking (i.e., an objective quantification) of the computed investment choices (i.e., an operation that objectively scores and ranks, in a manner specific to that client, all available investment choices within the various asset classes of investment choices computed in operation 206), thereby producing objectively ranked investment choices. In at least one embodiment of the inventive disclosures made herein, determining the objective ranking includes objectively and client-specifically determining a performance score (discussed below in greater detail) for each of the investment choices and ranking the investment choices dependent upon information derived from the client-specific performance scores.

In one embodiment, determining the investment choices includes applying a logic conditional filter to at least one of potentially many performance and structural factors expressed as numeric information, alphanumerical information and/or date information. For example, such a conditional filter is used for omitting funds that are closed (i.e., not accepting investments from new investors), or that have other structural or situational characteristics (i.e., factors) that are not desired or appropriate (e.g., investment amount exceeds an investment amount prescribed) for a client. In one embodiment, determining investment choices includes determining the investment choices dependent upon information derived from different aspects of the client-specific template (i.e., different client-specific template information). Such determining is, in at least one embodiment of the inventive disclosures made herein, performed by a first decision engine of the decision-assistance platform, whereby resulting information compiled by the first decision engine is subsequently provided to the second decision engine of the decision-engine platform, thus enabling a scoring and ranking process to be carried out by the second decision engine. In one embodiment, the client-specific template include one or more of potentially many filters and weightings, with one or more of the filters and weightings being applied to performance factor information, client information, investment opportunity information, and/or investment performance information.

After determining the objective ranking, the decision assistance platform performs an operation 210 for providing client-specific consulting information (e.g., investment choices, objective quantification thereof, etc). In one embodiment, such providing the client-specific consulting information includes preparing and outputting a client-specific investment report by a document assembly engine of the decision-assistance platform. In another embodiment, such providing the client-specific consulting information includes visually displaying such information. In another embodiment, such providing includes making such information accessible for related operations (not necessarily or specifically shown) of the method 200. Accordingly, it is disclosed herein that the decision assistance platform is preferably configured for preparation and output of information as printed and/or electronic documents (i.e., reports that are configured for being printed and/or electronically displayed).

A client-specific investment report as disclosed herein documents client-specific consulting information such as objectively ranked investment choices. Such client-specific consulting information (e.g., objectively ranked investment choices) is, preferably, presented in view of multiple variables that are dependent upon information derived from the financial objectives of the client. For example, various scenarios of investment choices may be presented that are dependent upon information derived from a plurality of desired investment effects and related computed performance scores. Such investment effects are dependent upon information derived from performance criteria. Broadly, performance criteria in accordance with the inventive disclosures made herein include criteria relating to return, risk, associated industry-prescribed asset classes, investment effect rules and correlating investments opportunities to client expectations. Specific examples of performance criteria and their related performance factors are depicted below in Table 1. Detailed information defining such performance criteria and their related performance factors are not discussed in detail, but would be understood by a person skilled in the related art (e.g., financial systems and methodologies).

TABLE 1
Performance Criteria and related Performance Factors

| Performance Criteria | Related Performance Factors |
|---|---|
| Annualized Return | N-Year Return, N-Year Average Return |
| Annualized Standard | N Year Standard Deviation |
| Deviation | |
| Index | Index Score, Composite Index Score |
| Yield | N-Year Yield |
| Beta | N-Year Beta |
| Market Capitalization | Average Market Capitalization |
| Sharpe Ratio | N-Year Sharpe Ratio |
| Turnover Ratio | N-Year Turnover Ratio |
| Treynor Ratio | N-Year Treynor Ratio |

In at least one embodiment of the client-specific investment report, the client-specific investment report includes charts and tables depicting investment allocation among various asset classes, statistical/historical performance of investment choices within various asset classes, distribution of composite performance scores for such investment choices, and client-specific scoring and ranking of such investment choices. In at least one embodiment, the client-specific investment report includes a client-specific assessment of available investment alternatives dependent upon information derived from an assessment of such available investment alternatives.

After reviewing the client-specific consulting information, the trusted advisor and/or the financial services consultant (in consultation with the client) may facilitate an operation 212 for revising decision criteria upon which the objective ranking of investment choices is based. Such revisions include revisions to performance criteria (e.g., factor selections and weightings) and modifying/clarifying information associated with client financial objectives. In response to the trusted advisor and/or the financial services consultant revising any of the decision criteria, the method precedes at the operation 206 for determining investment choices an objective-ranking (i.e., operation 208) dependent upon information derived from the revised criteria. In response to neither the trusted advisor nor the financial services consultant revising any of the decision criteria, the method continues at an operation 214 for facilitating delivery of the client-specific consulting information (e.g., in the form of a client-specific investment report) to the financial services client (e.g., the trusted advisor initiating electronic submission of the information by the decision assistance platform or the trusted advisor personally facilitating presentation of the information). After the financial services client selects one or more investment choices into which funds are to be allocated (e.g., after consultation with the trusted adviser), an operation 216 is performed (e.g., by the trusted advisor or financial services client) for inputting the selected investment choices into the decision assistance platform. Once funds are allocated, the selected investment choices represent an investment portfolio of the financial services client.

Periodically (e.g., quarterly), an operation 218 is performed via the decision-assistance platform for facilitating a comparative performance assessment of the investment portfolio, thereby generating periodic performance information (i.e., client-specific decision information). As discussed below in greater detail, the comparative performance assessment provides information for qualitatively and objectively assessing selected investment choices. After facilitating the comparative performance assessment of the investment portfolio, the decision assistance platform performs an operation 220 for providing such client-specific decision information for subsequent operations. One example of enabling such subsequent operations includes outputting of a periodic performance report comprising such periodic performance information at the request of the trusted adviser. In one embodiment, the periodic performance report is prepared and outputted by a document assembly engine of the decision-assistance platform. After performing the operation 220 for providing such client-specific decision information, the trusted advisor performs an operation 222 for facilitating providing such information for review by the financial services client.

Preferably, a decision assistance platform as disclosed herein plays no role between the trusted advisor and the financial services client. However, in other embodiments, a decision assistance platform as disclosed herein does play a role between the trusted advisor and the financial services client. For example, the decision assistance platform may facilitate compilation of information directly from the financial services client or may provide investment choice information directly to the financial services client.

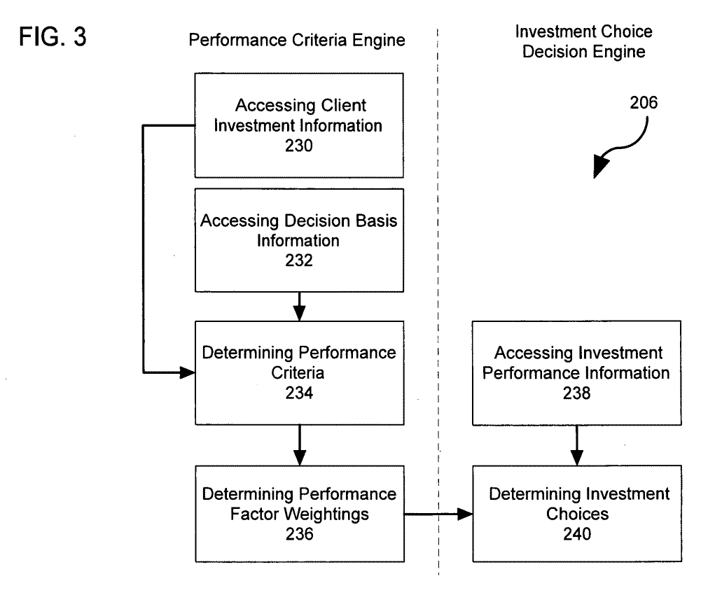

FIG. 3 depicts an embodiment of the operation 206 for determining the investment choices. An operation 230 is performed by a performance criteria decision engine (i.e., a first decision engine) of the decision-assistance platform for accessing client background information and an operation 232 is performed by the performance criteria decision engine for accessing decision basis information. In one embodiment, client background information and decision basis information are accessed from one or more databases by the performance criteria decision engine.

In response to the client background information and the decision basis information being accessed, an operation 234 is performed via the performance criteria decision engine for determining corresponding performance criteria (e.g., investment effect parameters). Examples of the corresponding investment effect parameters include parameters associated with risk of an investment, parameters associated with return on an investment, parameters associated with other structural and performance aspects of an investment, various investment allocation rules and parameters associated with correlating investment opportunities to client financial expectations. In at least one embodiment, the category of investment effect parameters includes investment allocation parameters. The performance criteria decision engine performs an operation 236 for determining performance-weighting factors dependent upon information derived from the investment effect parameters in response to determining the investment effect parameters. For example, a performance factor weighting of 0.80 and 0.20 may be used to compute and apply performance factors for risk minimization and return maximization, respectively. The 0.80/0.20 performance factor weighting ratio would correspond to a situation in which the client financial objectives indicate that the client is far more concerned with risk minimization than return maximization.

After determining the performance factor weightings, an investment choice decision engine (i.e. a second decision engine) of the decision-assistance platform performs an operation 238 for accessing investment performance information (e.g., risk, return, and other structural and performance information), followed by the investment choice decision engine performing an operation 240 for determining investment choices (i.e., performance quantified investment choices) dependent upon the client's individual investment needs, desires and/or goals. In some cases, the investment choices will be existing investments within an investment portfolio of the client. Preferably, the respective decision engines facilitate determining the performance selection and weighting factors, determining investment effect parameters, and determining an objective scoring and ranking of available investment choices without human intervention during the respective computation operations.

It is disclosed herein that functionality (e.g., operations) facilitated by the performance criteria decision engine (i.e., a first decision engine) of the decision-assistance platform may alternatively be facilitated manually by a person, rather than by the performance criteria decision engine. In such an embodiment, resulting information from the manually facilitated functionality is subsequently made available to the investment choice decision engine for enabling functionality of the investment choice decision engine to be facilitated.

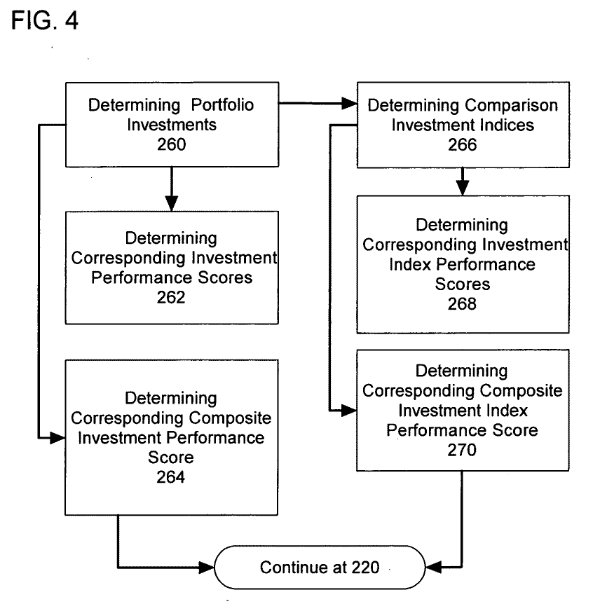

FIG. 4 depicts an embodiment of the operation 218 for performing the comparative performance assessment of the investment portfolio. An operation 260 is performed for determining portfolio investments (i.e., the investment choices that presently comprise the client's portfolio). In response to determining the portfolio investments, an operation 262 is performed for determining a corresponding investment performance score for each of the portfolio's individual investments and an operation 264 is performed for determining a corresponding composite investment performance score. The composite investment performance score is a composite score that represents an overall performance of all of the individual portfolio investments.

After the portfolio investments are determined, an operation 266 is performed for determining comparison investment indices corresponding to each one of the portfolio investments. The comparison investment indices are those indices that suitably correspond to each of the portfolio investments (e.g., within a corresponding asset class, exhibiting corresponding performance factors, etc). In response to determining the comparison investment indices, an operation 268 is performed for determining a corresponding investment index performance score for each of the comparison investment indices and an operation 270 is performed for determining a corresponding composite investment index performance score. The composite investment index performance score is a composite score that represents an overall performance of all of the individual investment indices. These individual and composite investment index performance scores are computed in the same manner (i.e., using the same performance factors and the same performance factor weightings) as is used in operations 262 and 264 described above. After determining the various performance scores, the operation 220 (FIG. 2B) is performed for providing such information for associated operations (e.g., for printing and/or displaying such periodic performance information).

It is contemplated that determining the composite investment index performance score may include combining the respective investment index indices dependent upon information derived from actual allocations of funds within the corresponding investment portfolio and/or upon at least one of criteria relating to risk and criteria relating to return. Similarly, it is contemplated that determining the composite investment performance score may include combining the respective portfolio investments dependent upon information derived from actual allocations of funds within the corresponding investment portfolio and/or upon at least one of criteria relating to risk and criteria relating to return. Furthermore, it is disclosed herein that a decision engine system of the decision assistance platform and/or a document assembly engine of the decision assistance platform may perform the functionality of the operation steps of 218 for performing the comparative performance assessment of the investment portfolio.

Accordingly, scoring and ranking of all available investment choices within each asset class within the client's portfolio is performed. The scoring and ranking is performed using the same performance parameters and parameter weightings used in the original scoring and ranking analysis (or the latest revised analysis) used by the client to select the client's investment choices. The various related investment indices are scored and ranked in exactly the same manner as the investment choices within the asset class for which a particular index is relevant. The scoring process produces a composite numerical score for each of the client's investment choices, all other available (yet unchosen) investment choices, and the relevant indices.

These numeric scores, when used to sort the results of the scoring (e.g., from the highest composite score to the lowest composite score), effectively and quantitatively compare all investment choices with each asset class (both chosen and unchosen) as well as the relevant indices. The highest scoring and, therefore, the highest ranking of the choices are those whose blended composite score (i.e., the score resulting from the blending of all of the individually weighted performance factors used in the scoring process) indicate those choices that the historic performance which most closely matches the investment performance desired by the client for a particular asset class being evaluated (i.e., the performance desired of that asset class, which was the reason for the inclusion of that asset class in the portfolio).

It is disclosed herein that the investment indices may correspond to asset classes corresponding to the individual portfolio investments. In such case, it is contemplated the comparative performance assessment is performed between allocated investment (i.e., those selected investment choices that are funded) and a plurality of non-allocated investments represented by the asset class (i.e., all or a portion of the investment choices that were not selected for being funded).

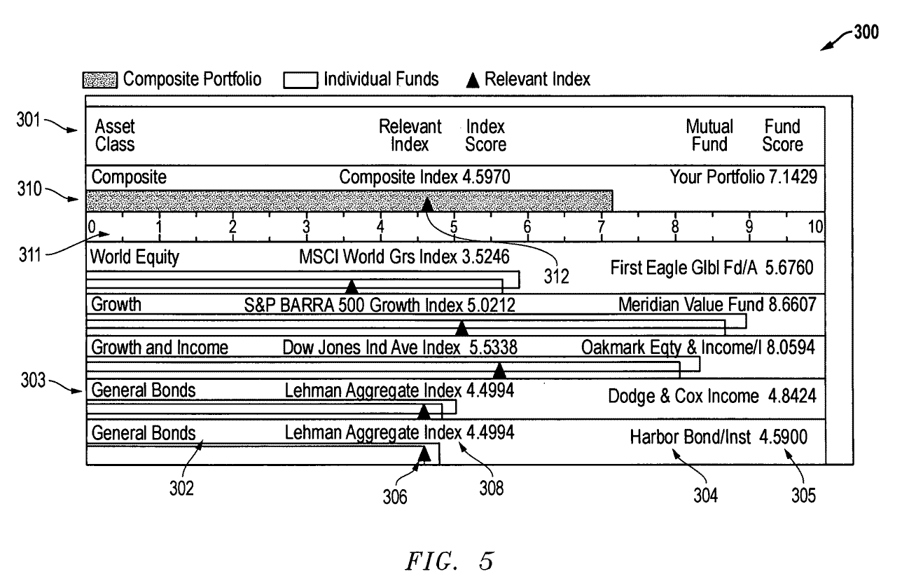

FIG. 5 is a chart 300 depicting a graphical representation of performance scores that are depicted in view of corresponding asset classes 301. In one example, the chart 300 is comprised by a periodic performance report. The composite performance score 302 for each one of the asset classes 303 within the portfolio is depicted by a first configuration of graphical indicia (e.g., a corresponding horizontal bar of a first color). Depicted in association with individual managers and/or funds 304 is a composite score 305. The performance score 306 of each one of the investment indices 308 is depicted by a second configuration of graphical indicia (e.g., a discrete symbol of a first color) superimposed over the first configuration of graphical indicia. The composite investment performance score 310 is depicted by a third configuration of graphical indicia ((e.g., a corresponding vertical bar of a second color). The composite index score 312 is depicted by a fourth configuration of graphical indicia (e.g., a triangle) superimposed over the third configuration of graphical indicia. In this manner, the selected investment choices of the financial services client are graphically compared to appropriate benchmarks.

The chart 300 of FIG. 5 is configured to provide a summary of portfolio performance, using bar graphs to represent scores resulting from an assessment of the individual funds comprising the portfolio as well as the portfolio as a whole. The chart 300 provides a means for measuring overall portfolio performance, by comparing the “Composite Portfolio” score (i.e., the bar adjacent to the term “Composite”) with the “Composite Index” score (i.e., the triangle superimposed on the bar adjacent to the term Composite). As depicted, the composite portfolio bar extends beyond the location of the composite index triangle. The positive differential indicated that the Composite Portfolio is outperforming the Composite Index in meeting stated performance goals. The chart 300 similarly depicts the performance of individual portfolio investments in relation to individual composite index components.

The graphical representation of the composite investment performance score 310 is proportional to a blended score (i.e., discussed in the following paragraph in greater detail) of the portfolio and is positioned along a performance scale 311 such that its score can be compared to the composite index score 312 of the investment portfolio as a whole. The performance scale 311 serves as a means for measuring performance (e.g., scores) based on relative position of graphical representations depicting such scores. The graphical representation of each asset class performance score 302 is proportional to the composite score of individual fund (or manager) and is positioned the performance scale 311 such that its each performance score 302 can be compared to its fund's relevant composite index score 312. The graphical representation of a fund's relevant composite index score 312 represents the performance of the respective fund.

The composite performance scores 302 for each individual fund and related asset class 303 provide a summary of the performance assessment performed on each of the portfolios asset classes. Additionally, blending of the performance scores of the individual funds held is used in determining the composite investment performance score 310. The scores of relevant indices 308 are similarly blended and used in determining the composite index score 312. In one embodiment, such blending is accomplished by using current market value of individual manager's holdings and the proportional percentage of those holdings with respect to the total value of the portfolio. For example, in an instance where the value of the manager's holdings were $5,000,000 and the total portfolio value were $100,000,000, 5% of the composite portfolio score 302 would be attributed to the composite investment score of that manager. Furthermore, the same proportion of. 5% would apply to the manager's relevant index score and the blending determination of the composite index score.

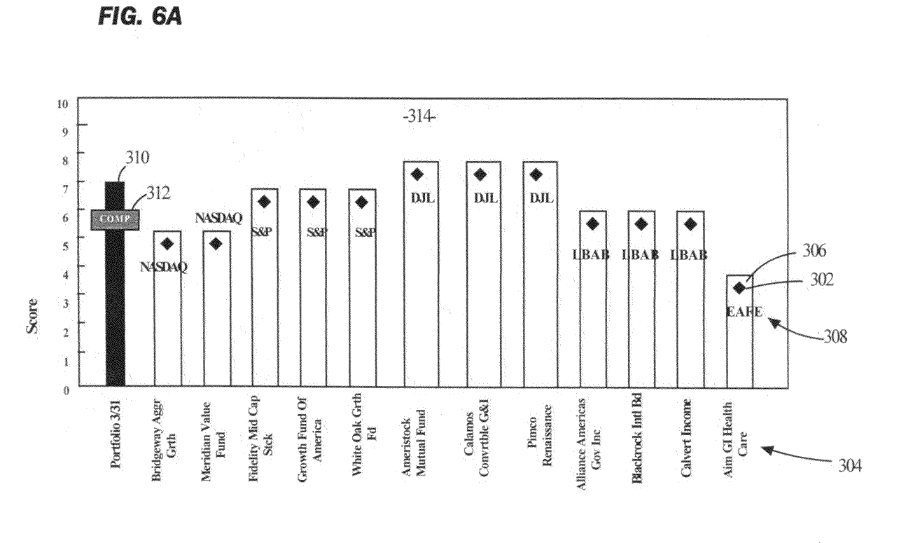

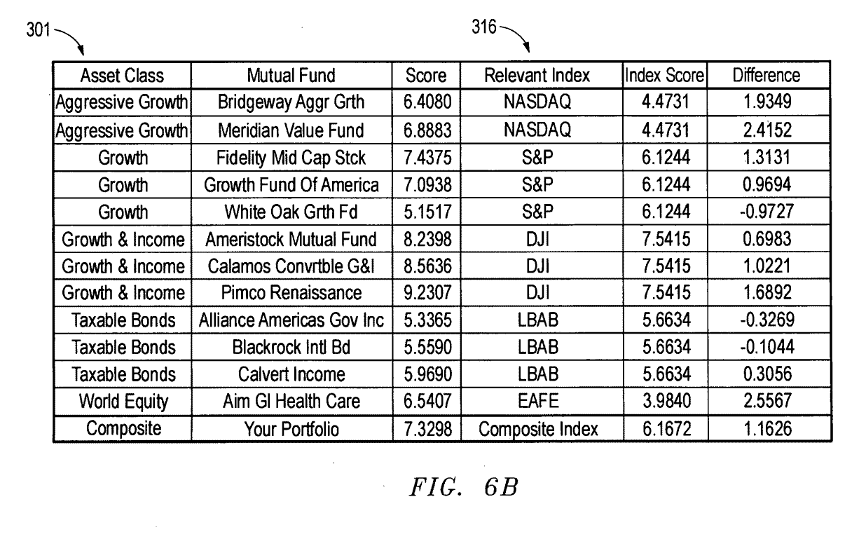

The chart 314 of FIG. 6A and the table 316 of FIG. 6B jointly depict an alternate embodiment for presenting the information depicted in the chart 300 of FIG. 5. While essentially the same information is presented in FIG. 5 as jointly depicted in FIGS. 6A and 6B, presentation in accordance with the chart of FIG. 5 is advantageous in that it allows a greater volume of information to be presented in a given amount of space (i.e., with respect to the presentation approach of FIGS. 6A and 6B).

It is disclosed herein that the charts depicted in FIGS. 5, 6A and 6B are examples of information configured for enabling objective and comparative assessment of investment choices to be made by an investor/financial services client. It is also disclosed herein that operations and/or approaches for generating all or a portion of the information comprised by the charts depicted in FIGS. 5, 6A and 6B are examples of assessing such information and/or enabling comparative assessment of such information.

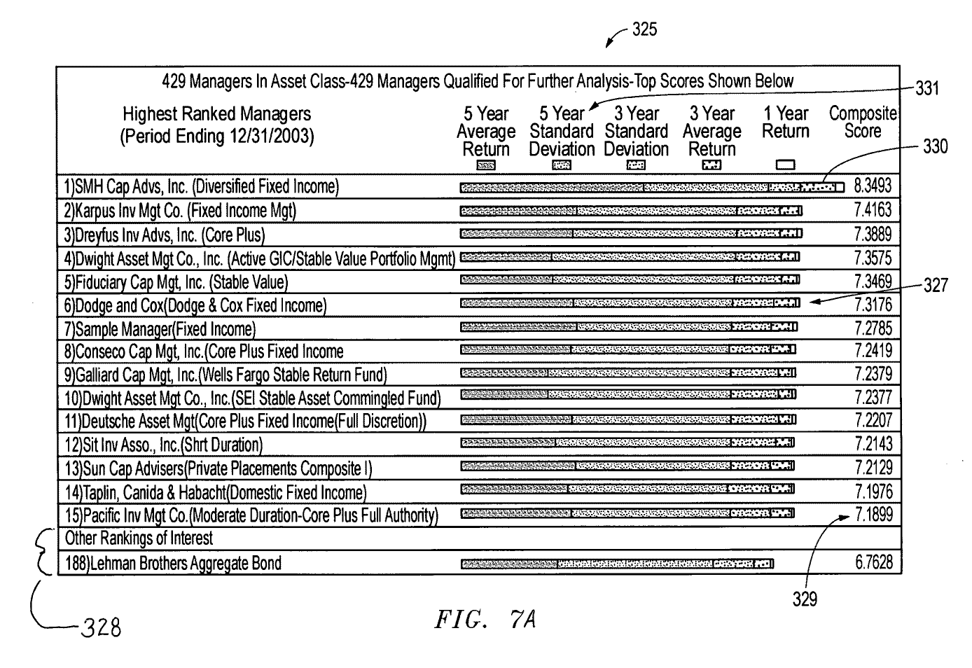

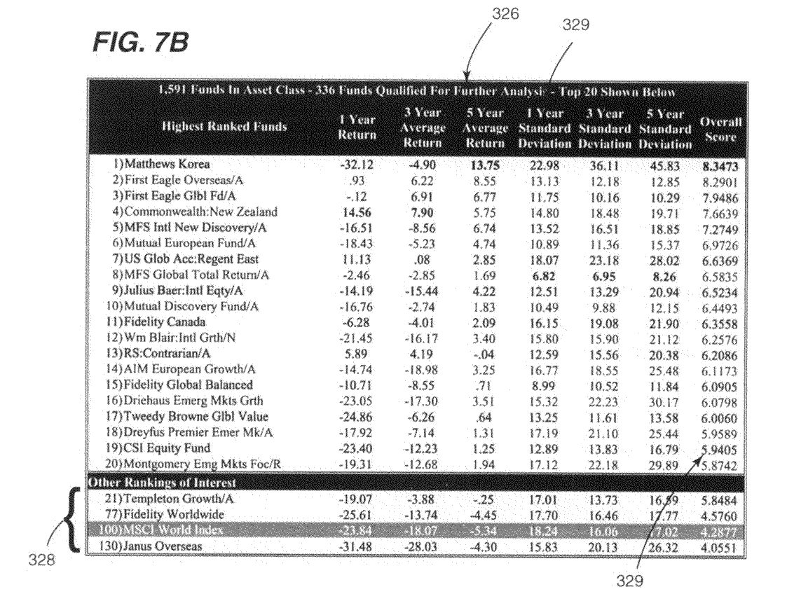

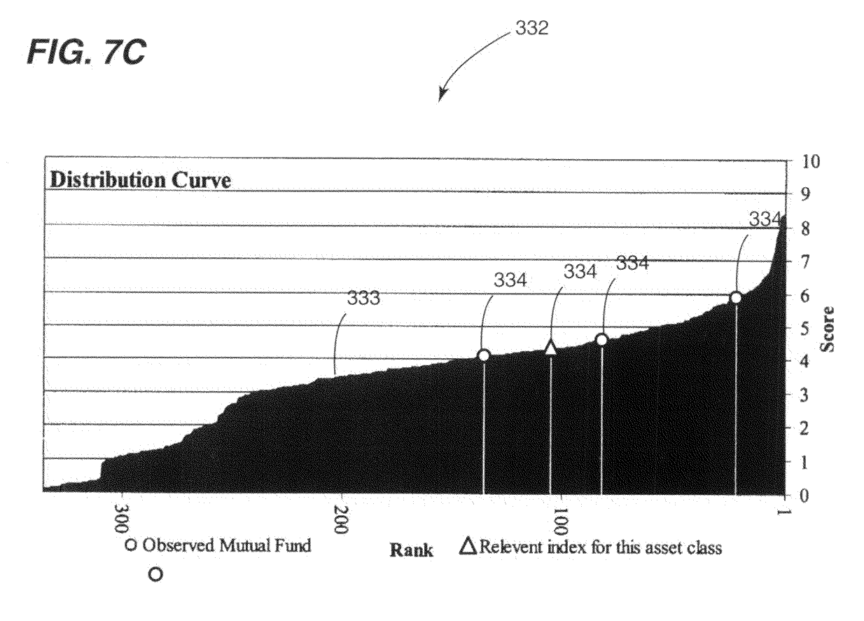

FIG. 7A depicts a table 325 including a plurality of performance-quantified investment choices for a particular asset class and having a plurality of multi-segment bars 327 (e.g., bars with different color segments) that each graphically represents performance information (e.g., a corresponding composite score 329) for each of the performance-quantified investment choices. The lengths of each multi-segment bar 327 is proportional to its corresponding composite score 329 and, for comparison purposes, relative to all of the composite scores shown. The various segments 330 of each bar 327 represent the relative performance of the corresponding weighted performance criteria. The length of each segment 330 represents a performance criteria's weighted performance, as compared against a group of its peers within the same asset class. Longer segments proportionally represent a larger impact on the composite score. The order of the segments of each bar match the display order of the performance criteria labels 331 (e.g., 5-year return) in the header section of the table 325. However, in certain instances, a particular segment of a particular bar will not be depicted, representing that a manager is either missing data for the corresponding performance criteria or that a combination of minimal weighting and/or poor performance has cause that performance criteria to have little to no impact on the corresponding composite score.

Performance of a fund and its manager is typically considered within the context of a specific performance factor. For example, 5-year average return could be sorted to find out which manager had the highest return over a five-year period. However, when multiple performance factors (i.e., performance criteria used for decision making purposes) are used simultaneously to evaluate a manager's performance, the combining of each factor's performance is done in a manner that produces a composite score that can be used to evaluate the manager's/fund's overall performance. Once multiple performance criteria (which are functionally used as decision criteria) are selected, individual weightings can be assigned to each of the performance criteria so that the overall manager performance can be defined to the specific performance and decision requirements (e.g., needs, goals, risk tolerances, etc) of the investor (i.e., the financial services client). Having a visual representation of how weighted performance criteria impact the composite scores is useful for quickly identifying which decision criteria are having the most impact on the composite scores.

Relative performance of performance criteria (i.e., criteria utilized for making investment decisions) in accordance with the inventive disclosures made herein may be assessed relative to one or more points of reference. Relative performance of decision criteria against all peers is a first point of reference. For example, comparing the length of the 5-Year Average Return segments in the Table 325 of FIG. 7A indicates roughly a 35% difference in length favoring the top rated manager, which is translated to same difference in performance as it relates to its peer group. Performance as it relates to the peer group is calculated using a scale of 5-Year Average Return values. All of the performance criteria's peers define this scale and each performance score is applied to that scale to find its relative rank within the group. Because the graphical representation of performance takes each performance criteria's scale into consideration, it is useful for comparing performance of performance criteria scores quickly. Thus, large differences in performance between managers can be identified easily.

Relative performance of the performance criteria as it relates to the composite performance score is a second point of reference. Performance criteria weightings are not mentioned when evaluating the relative performance of performance criteria relative to all bears. This is because the weighting assigned to each performance criteria is applied equally to the group of peers. However, the weightings assigned to each performance criteria directly influence determination of the composite score. For example, comparing the length of all the segments for the top manager shows that the majority of the weighting has been placed on the 5-Year Return and 5-Year Standard Deviation. For this example, 80% of the weighting is placed on the combination of those two performance criteria, which means that on a composite scoring scale of 0 to 10, these two performance criteria can add as much as 8 points to the composite score. Unlike the 5-Year performance criteria, the combined weightings of the 3-Year Return and 3-Year Standard Deviation are only weighted at 17.5%, which can add as much as 1.75 points to the composite score. The weighting assigned to each performance criteria acts as a multiplier that defines the maximum impact that the performance criteria can have one the composite score and also the maximum length of the corresponding segment of the bar in Table 2. The effect of the weighting can be seen easily by comparing the sizes of the 5-Year performance criteria to the 3-Year performance criteria.

FIG. 7B depicts a table 326 comprised by tabular data representing performance information for performance-quantified investment choices for a particular asset class. The table 326 depicted in FIG. 7B provides similar performance information as the table 325 depicted in FIG. 7A. However, the bulk of the performance information depicted in FIG. 7A is depicted graphically via the multi-segment bars 327 while the bulk of the performance information depicted in FIG. 7B is depicted in a tabular (i.e., numeric) format. Specifically, composite scores 329 and performance criteria values for performance criteria designated by performance criteria labels 331 are presented in a tabular format.

Table 325 depicted in FIG. 7A and the table 326 depicted in FIG. 7B both depict ‘Other Rankings of Interest’ 328. Examples of such other ranking of interest include, but are not limited to, allocated investments within a current investment portfolio and the asset class index that most closely matches the performance of the particular asset class. In one embodiment, the allocated investments within a current investment portfolio are designated via a respective visual indicia (e.g., a background of a first color) and the asset class index that most closely matches the performance of the particular asset class is designated via a second visual indicia (e.g., a background of a second color).

FIG. 7C depicts a composite performance score distribution graph 332 for the investment choices depicted in the table 326 of FIG. 7B. A curve 333 is generated through plotting of the composite performance scores 329 for each of the performance-quantified investment choices and the other rankings of interest 328. Visual indicators 334 depict performance scores for the other rankings of interest 328. For example, a circle designates an allocated investment within the current investment portfolio and a triangle designates the asset class index that most closely matches the performance of the particular asset class.

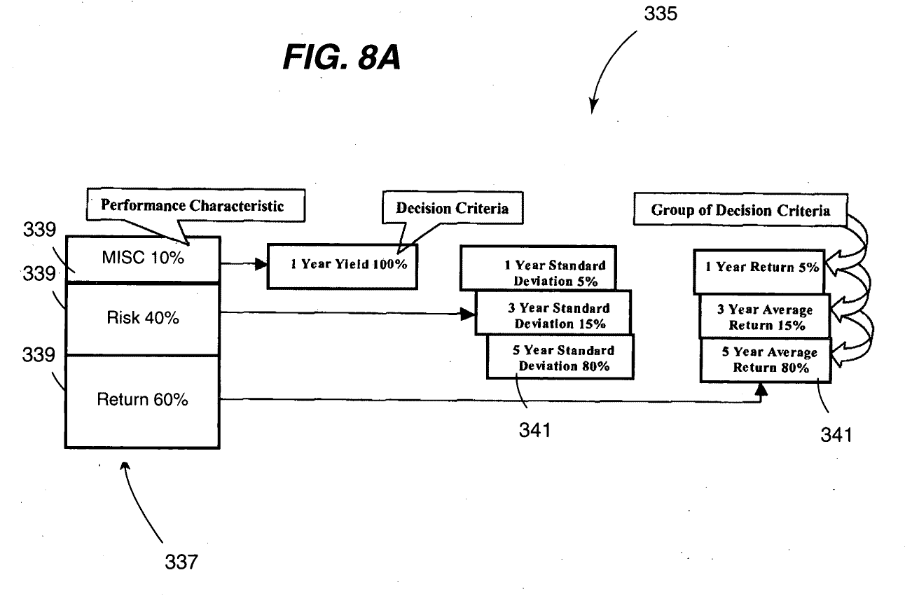

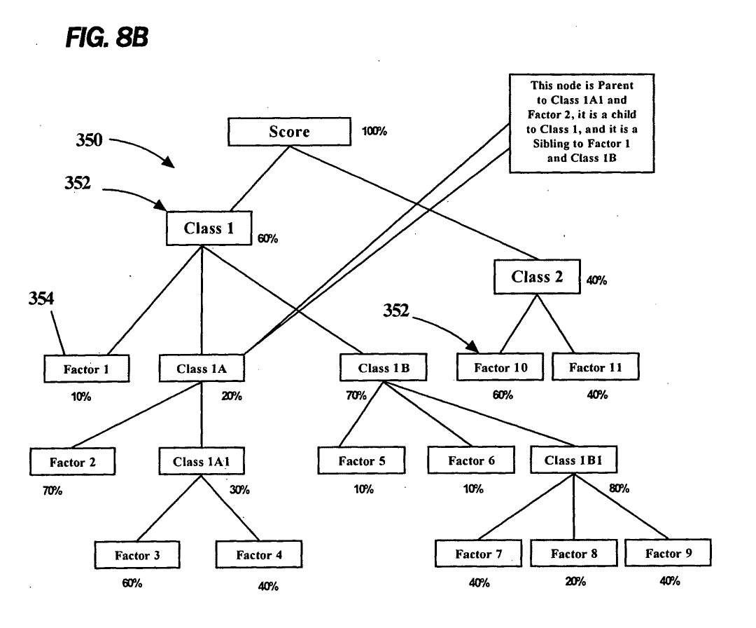

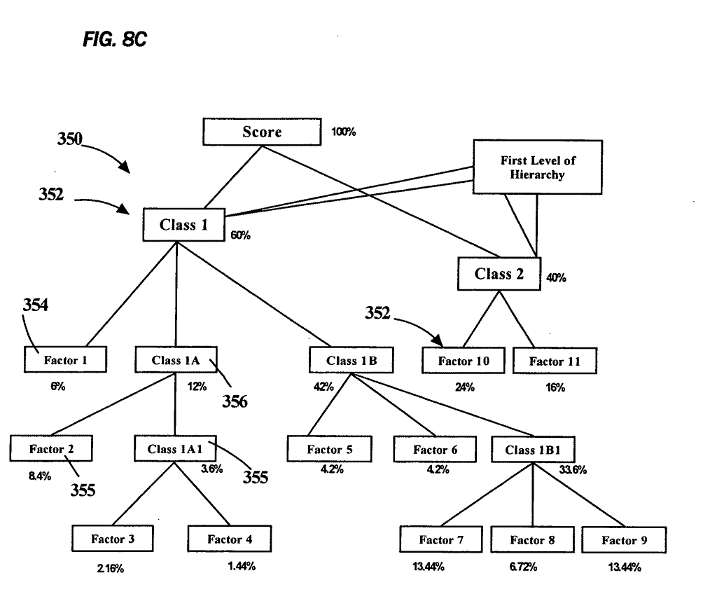

FIG. 8A depicts an embodiment of a weighting approach 335 for facilitating a performance assessment in accordance with the inventive disclosures made herein. The weighting approach 335 depicts a manner in which a performance assessment of managers is performed within each of the asset classes and shows a relationship of performance characteristics and performance criteria that have been used. The multi-segment vertical bar 337 depicts a grouping of performance criteria 339 used in the assessment and the degree of influence (i.e., weighting) assigned to each. Each one of the performance criteria 339 of the vertical bar 337 has one or more subtending performance factors 341 associated therewith. The performance factors 341 that relate to common performance criteria 339 subtend from that particular performance criteria 339, thus producing groupings of performance factors in some instances.

Weightings are individually assigned to the performance factors 341 and indicate how much influence each of the performance factors 341 has within its group. Increasing any one performance factor's weighting within a group results in a corresponding degrease in the weighting assigned to the one or more other performance factors in the group. In effect, the sum of all of the performance factor weightings within a group must always sum to 100%. The same applies to the sum of all of the weightings applied to the performance criteria 339 from which all of the performance factors 341 subtend.

Weighting of the various performance criteria 339 and performance factors 341 influence performance scores referred to herein. Specifically, each grouping of performance scores has a direct effect on a performance score. Because a 50% weighting has been applied to one of the performance criteria 339, that performance criteria will control 50% of a performance scale (e.g., 5 points of the 10-point scale). The individual performance factors 341 subtending from each performance criteria 339 have an indirect affect upon the performance score. That indirect affect is determined by multiplying the weight assigned to that performance factor 341 and the weight of the performance criteria 339 from which it subtends.

In one specific embodiment of the weighting approach 335 depicted in FIG. 8A, the performance criteria 339 are paired instances of risk performance criteria and return performance criteria (i.e., miscellaneous performance criteria are omitted). In this specific embodiment, the sum of weighting applied to the risk and return performance criteria sum to 100%. A skilled person will appreciate that the present invention is not limited to a particular number of performance criterion used in the weighting approach 335. A single performance criterion can be used, as it could be 100% of the weighting. For example, Return is sometimes the only performance criterion on very conservative asset classes, as the risk is effectively the same on all the available choices. Accordingly, it is disclosed herein that one or more performance criterion may be used in the weighting approach 335.

FIGS. 8B and 8C depict an embodiment of a hierarchical weightings structure that represents an approach for utilizing the weightings for determining performance scores. In effect, the weighting structure depicted in FIGS. 8B and 8C and the weighting approach 330 depicted in FIG. 8A accomplish the same objective and produce the same type of information. The difference is simply a matter of presentation.

The hierarchical structure includes a tree structure 350 where nodes 352 of the tree structure 350 are either classes or performance factors (depicted as ‘factor’ in FIGS. 8B and 8C). The tree structure 350 serves to distribute weightings to the performance factors. The weightings assigned to the performance factors define the potential impact that a performance factor may have on the scoring and ranking performed during an assessment (e.g., the comparative performance assessment discussed above) of investment information.

Performance factors are the ‘leaves’ of the tree and correspond directly to the performance data recorded in a corresponding dataset (i.e., investment performance information). Performance factors are always an end node 354 of any branch in the tree 350. As depicted in FIG. 8B, ‘Class 1A’ is a parent class node to ‘Factor 2’ (i.e., a child class node to ‘Class 1A’), it is itself a child class node to ‘Class 1’ (i.e., the parent class node of ‘Class 1A’) and it is a sibling class node to ‘Factor 1’ and ‘Class 1B’ (i.e., the sibling class nodes of ‘Class 1A’).

Classes are a group of performance factors or some combination of performance factors and classes. Only classes may be parent class nodes, but they can also be child class nodes or sibling class nodes. Factors may never be parent class nodes, and may only be child class nodes or sibling class nodes. Nodes on the same hierarchal level that are assigned to the same parent class node, will add up to 100%. Or, if they do not add to 100%, they are reduced to sum up to 100% while maintaining the weighting relationship between the assigned performance factors and classes. The performance factors that are assigned to classes are typically similar or share some common theme. The purpose of the classes is to have a way to influence the relative weightings of all the subtending classes and performance factors that have a relationship to a parent class.

All nodes 352 within the tree 350 have an assigned and/or a calculated weight. These weights can be assigned via a template, by manual entry or, though some other type of decision process (e.g., that of the performance criteria decision engine disclosed herein). It is necessary to normalize the weightings of all of the nodes 352 to 100%, so that their weightings are relative to subtending parent class nodes. Once normalized into a relative weighting, an actual weighting can be calculated for each of the class nodes.

As depicted in FIG. 8C, actual weights are calculated based on the relative weightings of the nodes 352 in the weightings hierarchy. Actual weightings influence the scoring and ranking that takes place during an assessment of investment information. Each nodes relative weight is multiplied by the actual weight of its parent node, which produces the actual weight of each one of the nodes 352. The hierarchy is processed from the highest node in the tree 350 to the lowest nodes in the tree, because the actual weight of parent class nodes is required to calculate the actual weight of its children (i.e., child class nodes). The actual weightings are then applied to investment performance data to generate a corresponding factor performance score. These individual factor performance scores are then combined to to produce a composite performance score.

Using a hierarchical weighting structure is advantageous in that it enables the effect of different weighting scales to be blended. Blending such scales through the use of weighting allows evaluation of performance factor values using various different scoring methods. For example, though such blending, blended investment index performance scores and a corresponding blended composite investment index performance score may be computed. As depicted in FIG. 8C, blended tree fragments 355 represent a plurality of performance factor weightings that sum to the weighting of a respective parent node 356.

One specific application for decision assistance functionality in accordance with the inventive disclosures made herein is for facilitating management of 401K retirement savings plans (i.e., the Plan). Through such decision assistance functionality, analysis of a 401K retirement savings plan may be facilitated. In one embodiment, there are four goals associated with such analysis. A first goal is to review the current delivery method used by the Trustee for the 401K retirement savings plan. A second goal is to identify appropriate asset classes to be represented by investments in the Plan. A third goal is to objectively analyze specific investment options for participants and the Trustee (or Trustees) of the Plan. A fourth goal is to enable establish a defendable investment policy which includes a defendable methodology that the Trustee (or Trustees) may rely upon for the selection and on-going monitoring of investment options.

To provide participants in a 401K retirement savings plan with an array of investment options that are appropriate for commonly identifiable levels of investment experience, risk tolerance, return goals and the like, it is assumed that the Plan accommodates a broad variety of participant profiles. By using model portfolios derived from a predicted type of investment experience in which a particular type of participant would like to partake, a logical basis from which to select investments best suited to plan participants may be formed. Commonly, such an approach is to offer an investment collection of proprietary funds and then retrofit them to such model portfolios.

Table 2 below discloses six (6) participants and corresponding participant profiles. These profiles are intended to represent broad investment preferences of a diverse participant population as opposed to being intended to be exhaustive.

TABLE 2
Plan Participant Profiles

| Participant Type | Profile Description |
|---|---|
| Highly | This investor is generally not interested in |
| Conservative | subjecting the principle of their investment |
| Investor | to any potential for loss. This investor is |
| | primarily concerned with maintaining their |
| | current portfolio value and keeping pace, if |
| | possible, with inflation. |
| Conservative | This investor is generally interested in |
| Investor | taking on only enough risk to provide the |
| | chance to achieve total portfolio returns |
| | marginally higher than what could be expected |
| | from a money market account in order to keep |
| | pace with inflation (e.g., in order to avoid |
| | a loss of purchasing power through inflation). |
| Moderately | Although this investor would rather consider |
| Conservative | himself/herself conservative, they would |
| Investor | typically wish to be “fully invested” rather |
| | than having their money sitting in a stable |
| | value account. To this end, they are willing |
| | to subject a portion of their investments to |
| | the volatility of stock and bond markets. |
| Moderate | A moderate investor is almost always “fully |
| Investor | invested” and tends to have investments that |
| | evenly span sock and bond asset classes. |
| Moderately | This type of investor is comfortable |
| Aggressive | accepting substantial levels of risk in pursuit |
| Investor | of strong asset growth. Although a typical |
| | portfolio for this type of person may favor |
| | equity investments, it is very likely that they |
| | still maintain a sense of restraint and |
| | therefore diversify some percentage of their |
| | investments into fixed income positions. |
| Aggressive | This type of investor generally has a long |
| Investor | time frame and, therefore, the tolerance to |
| | withstand significant volatility in exchange |
| | for the potential of unusually high returns. |
| | This type of investor is frequently almost |
| | exclusively invested in equity funds. |

FIG. 9A depicts asset class allocation for each of the participant profiles presented in Table 2. The six participant profiles depicted in FIG. 9A are intended to generally correspond to investment preferences and risk tolerances of the majority of participants in the Plan. Each one of the participant profiles 380 includes a graphical allocation representation (e.g., a pie chart) of a respective model portfolio 382 comprised by one or more segments 384 corresponding proportionally to an allocated amount of a respective asset class 386.

In one embodiment, the methodology for allocating assets to the participant profiles are based on a Nobel Prize winning theory, which asserts that the majority of a portfolio's overall rate of return is determined by the asset classes rather than individual investments or timing of those investments within the asset classes. Furthermore, the theory holds that, within a defined set of asset classes, there are optimal portfolios for each specific level of risk tolerance. These portfolios represent the maximum potential rates of return that cannot be exceeded without assuming significantly greater degrees of risk.

FIG. 9B depicts an asset class structure 381 that depicts each one of the asset classes of FIG. 9A relative to a degree of risk (i.e., ranging between most aggressive to least aggressive) and a degree of return (i.e., ranging between most conservative and least conservative). Additionally, each one of the model portfolios of FIG. 9A and Table 2 is depicted in comparison with all other model portfolios with the corresponding asset class blends for each of the model portfolios relative to a degree of risk. For every model portfolio 382 in which an asset class 386 resides, different investment criteria weightings (See FIGS. 8A through 8C) are used to determine which investment options are appropriate for a participant's particular level of risk aggressiveness and return conservations. Through such investment criteria weightings, scoring and ranking methodologies in accordance with the inventive disclosures made herein enable the most appropriate investment options within each asset class to be determined.

Because investors with varying investment goals and tolerance to risk place differing degrees of emphasis on certain performance criteria, investment options within each asset class must be analyzed under multiple scenarios in order to accommodate the needs of all of the types of investors that may comprise the totality of plan participants. FIG. 9C depicts an embodiment of a weighting and performance criteria structure 390 for enabling analysis of such multiple scenarios of an asset class. For a given asset class, a return weighting 392 and a risk weighting 394 are provided for applicable participant profiles. Through such various weightings, it may be determined through a resulting investment performance score that a particular asset class applies to a plurality of participant profiles (e.g., as broadly depicted in FIG. 9B). For each set of weightings and performance criteria, detailed investment options for each respective asset class will be determined and presented via a table such as that depicted in FIG. 7A or 7B.

Various information prepared and determined in accordance with the inventive disclosures made herein (i.e., information elements) may be compiled to facilitate management of a 401K retirement savings plan. Such compilation of informational elements represents a consultation analysis that may be in the form of a written report (e.g., a published document), electronically accessible report (e.g., via a website) or both. Information elements of such analysis may very dependent upon specifics such as the client, types of company, types of participants, type of plan, intended result of the consultation analysis, etc.

In one embodiment of a consultation analysis, the consultation analysis includes a plurality of preferred informational elements. Participant profiles (e.g., in accordance with Table 2) are a first one of the informational elements and are provided for each one of a plurality of classes of participants in the 401K retirement savings plan. A model portfolio (e.g., as depicted in FIG. 9A) is a second one of the informational elements and is provided for each one of the participant profiles. At least a portion of the model portfolios includes a plurality of asset classes. Designation of a plurality of performance-quantified investment choices for each one of the asset classes (e.g., as depicted in FIG. 7A or 7B) is a third informational element. Designation of the performance quantified investment choices are performance-quantified with respect to at least one performance factor. Designation of a plurality of suggested ones of the investment choices (e.g., as selected from the choices in FIG. 7A or 7B) for each one of the asset classes is a fourth informational element. The performance-quantified investment choices are quantified with respect to corresponding degrees of risk and return and weightings applied to performance criteria corresponding to quantifying risk and return are depicted. Additionally, the performance-quantified investment choices are each quantified with respect to a respective performance score, whereby the performance-quantified investment choices for at least one of the asset classes are depicted relative to a plurality of different corresponding degrees of risk and return.

Other informational elements include an asset class graphic representation (e.g., as depicted in FIG. 9B) depicting each one of the asset classes relative to a degree of risk and a degree of return, designation of at least one allocated investment of the 401K retirement savings plan (e.g., as depicted as other rankings of interest in FIG. 7A or 7B) in at least one of the asset classes, and/or a performance score comparison (e.g., as depicted in FIG. 7C) for each one of the asset classes. Each one of the model portfolios is depicted relative to corresponding ones of the asset classes. Performance of the at least one allocated investment of the 401K retirement savings plan is quantified relative to the performance-quantified investment choices for the corresponding one of the asset classes. The performance score comparison depicts relative performance of the performance-quantified investment choices and the at least one allocated investment of the 401K retirement savings plan.

In a specific embodiment of review of a 401K retirement savings plan, it is desirable and advantageous to utilize composite investment index performance scores and composite investment performance scores. More specifically, composite investment index performance scores and composite investment performance scores, as well as associated charts and tables (e.g., those depicted in FIGS. 5, 6A and 6B), are useful and valuable information to be used in assessing model portfolios in association with review of a 401K retirement savings plan. In such a specific embodiment, calculation of composite investment index performance scores and composite investment performance scores are based on intended asset allocation (i.e., the intended blend of funds of each model portfolio) as opposed to an actual asset allocation (i.e., the actual market value of plan participant funds) that is currently in place. Intended asset allocation refers an asset allocation that a plan participant has decided to implement, an asset allocation that has been suggested to the plan participant and/or an asset allocation that that plan participant is considering implementing. Through use of such intended asset allocation as opposed to actual account asset allocation, theoretical performance for each one of the model portfolios may be generated in a quantitative manner.

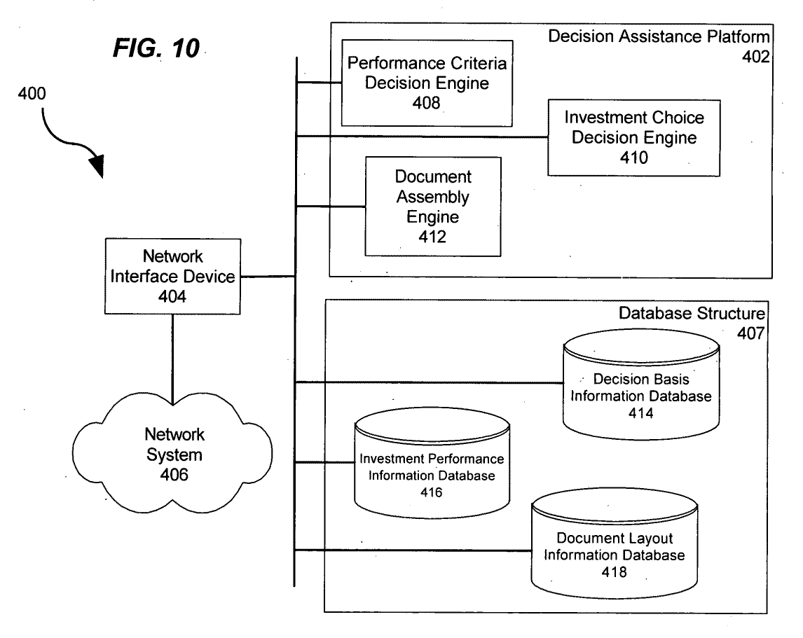

FIG. 10 depicts a network system 400 (i.e., a data processing system) configured for facilitating financial consulting services functionality in accordance with embodiments of the inventive disclosures made herein. The system 400 includes a decision-assistance platform 402, a network interface device 404 coupled to the decision-assistance platform 402, a network system 406 coupled to the network interface device 404. The decision assistance platform 402 comprises a database structure 407 accessible by the decision-assistance platform 402. Accordingly, communication of information between the decision-assistance platform 402 and other entities (e.g., a computer of a client, a computer of a financial services consultant, a computer capable of downloading investment performance information, etc) is enabled and accessibility of information required for carrying out such financial consulting services functionality is enabled (e.g., via accessing a website from which such functionality is accessible).

The decision-assistance platform 402 includes a performance criteria decision engine 408 (i.e., a first decision engine), an investment choice decision engine 410 (i.e., a second decision engine) and a document assembly engine 412. The performance criteria decision engine 408 is an example of a means for carrying out performance weighting factor computation functionality as disclosed herein. Such computation of performance weighting factors may include information comprised by the client-specific template (e.g., logic conditional filters and/or processing instructions).

In at least one embodiment of the inventive disclosures made herein, the first decision engine is configured for facilitating initial allocation functionality (e.g., facilitating appropriate client-specific allocations of investments and investment effect parameters). The investment choice decision engine 410 is an example of a means for carrying out comparative scoring and ranking (i.e., quantification) of investment choices computation functionality as disclosed herein. A decision engine system of a decision assistance platform is defined herein to comprise the performance criteria decision engine and the investment choice decision engine. The document assembly engine 412 is an example of a means for carrying out document preparation/outputting functionality as disclosed herein. It is contemplated that the various engines may be physically embodied as separate or fully integrated software/hardware modules.

The database structure 407 includes a decision information database (which may include rules set) 414, an investment performance information database 416, and a client information and document layout information database 418. In at least one other embodiment, separate client information and document layout information databases are provided. Information (e.g., rules) upon which the decision assistance platform 402 is dependent for carrying out performance criteria decision functionality as disclosed herein is maintained in the decision information database 414. Information upon which the decision assistance platform 402 is dependent for carrying out scoring and ranking computation functionality (i.e., of investment choices) as disclosed herein is maintained in the investment to performance information database 416. Information upon which the decision assistance platform 402 is dependent for carrying out document preparation/outputting functionality as disclosed herein is maintained in the client information and document layout information database 418.

It is disclosed herein that, in at least one embodiment of the inventive disclosures made herein, the decision assistance platform 402 is not a physically distinct apparatus or system. Rather, in such at least one embodiment, the decision assistance platform 402 is a functional platform comprised by functionality imparted across a plurality of systems or system components (e.g., discrete functional blocks linked via a network system). Accordingly, it is disclosed herein that system elements configured for imparting such functionality may be or may not be located at a common location and may or may not reside on a common computer.

It is disclosed herein that, in at least one embodiment of the inventive disclosures made herein, the decision assistance platform 402 comprises a single decision engine (e.g., a single data processing program) configured for facilitating all or a portion of the functionality of the 408, an investment choice decision engine 410 and a document assembly engine 412. In one example, a single decision engine program running on a suitable data processing system facilitates all or a portion of the functionality of the 408, an investment choice decision engine 410 and a document assembly engine 412 via a single data processing program. In another example, a single decision engine is fashioned to include various functional modules that interact to facilitate all or a portion of the functionality of the 408, an investment choice decision engine 410 and a document assembly engine 412.

Referring now to computer readable medium in accordance with embodiments of the inventive disclosures made herein, methods as disclosed herein are tangibly embodied by computer readable medium having instructions thereon for carrying out such methods. In one specific example, instructions are provided for carrying out the various operations of the method 100 depicted in FIGS. 2A and 2B for facilitating financial consulting services. The instructions may be accessible by the decision-assistance platform from a memory apparatus of the decision assistance platform (e.g. RAM, ROM, virtual memory, hard drive memory, etc), from an apparatus readable by a drive unit of the decision assistance platform (e.g., a diskette, a compact disk, a tape cartridge, etc) or both. Examples of computer readable medium include a compact disk or a hard drive, which has imaged thereon a computer program for carrying out financial consulting services functionality in accordance with embodiments of the inventive disclosures made herein.

Although the discussion of method and systems in accordance with embodiments of the inventive disclosures made herein have been presented thus far in view of financial utility to investors, it is contemplated that such methods and systems may be configured specifically for providing utility in the areas of commercial and residential lending, venture capital funding, investment banking services. Furthermore, it is contemplated that such methods and systems may be configured for providing utility beyond financial services. Specifically, embodiments of the decision-assistance platform functionality disclosed herein may be applied in applications other than financial services. Retail e-commerce applications, market research applications, human resource applications, dating services and raw material procurement are examples of such applications where an objective and unbiased scoring and ranking assessment of all available choices (i.e., within any universe of choices, the differences among them which may be quantified) functionality, consistent with a client's (or consumer's) individual needs, goals and/or desires, provided by the decision-assistance platform functionality are useful.

The inventive disclosures made herein relate to facilitating financial consulting services. Methods and equipment in accordance with embodiments of the inventive disclosures made herein are configured for enabling quantitatively ranked investment choices to be offered to clients by trusted advisers (e.g., attorneys, lawyers, siblings, community bankers, and the like) who are not necessarily professionals within the traditional financial services industry. The trusted advisor is thus armed with the knowledge to coordinate all of their clients' financial services needs, not as product salespeople, but in their traditional role as the providers of independent advice. In doing so, the client is provided with an increased level of trust with respect to the financial information being provided and the person providing the financial information.

Methods in accordance with embodiments of the inventive disclosures made herein and system configured for carrying out such methods provide trusted advisors having access to such methods (i.e., affiliated trusted advisors) with a proprietary support arrangement including a decision assistance platform. The proprietary decision assistance platform enables the affiliated trusted advisors to advise their clients and to coordinate solutions to their needs, outsourcing the responsibility of product research, comparative assessment, implementation and acquisition. This unique outsourcing structure creates significant efficiencies and allows affiliated trusted advisors to largely confine their time to meeting with and advising their clients, which is the most important and best use of their time. It eliminates the need to refer clients away to brokers, insurance agents, and other product salespeople, allowing the affiliated trusted advisor to retain a large portion of revenues that they have traditionally referred away to such brokers, agents and salespeople.

Furthermore, methods and systems in accordance with embodiments of the inventive disclosures made herein are designed to address a number of increasingly important and troubling trends that both consumers and professional advisory firms are now facing. The growing complexity and range of available choices is creating increasing uncertainty and stress among clients and their advisors (i.e., those individuals trying to help them make informed decisions with regard to product selection), and is increasing the need for unbiased, trustworthy advice. As the range of available choices continues to proliferate and as the volume and complexity of information about them continues to grow, many investors simply do not have the time to become knowledgeable about what their choices are, much less having the time and the ability to confidently choose from among them. In essence, many investors no longer have the time or individual ability to be able to discern what is truly “best” for them and their families relative to investment choices.

With rapidly expanding access to an increasingly diverse array of financial products and service choices—as well as increasingly voluminous and complex information about such choices—consumers increasingly need help in objectively analyzing the universe of available investment choices in order to feel secure that they have done “the best” for themselves and their families. Embodiments of the inventive disclosures made herein provide solution to increasingly broad needs for objective, trustworthy advice. The significance of this solution will continue to grow in parallel with the growth and development of the knowledge-based economy and e-commerce. With proper methodologies, training, technological tools and support, affiliated trusted advisors who already possess the greatest degree of client trust will be able to successfully meet this expanding client need for more broad ranging, objective advice with respect to financial products.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for facilitating management of a retirement savings plan, comprising:
at least one data processing device of a data computing system accessing, from memory coupled to said at least one data processing device, instructions causing said at least one data processing device to provide a model portfolio for a participant of a retirement savings plan, wherein the model portfolio includes investments within at least one asset class and wherein said at least one asset class is selected for providing a desired investment effect by the participant for the savings plan;
said at least one data processing device accessing, from said memory, instructions causing said at least one data processing device to provide a plurality of available investment choices for said at least one asset class; and
said at least one data processing device accessing, from said memory, instructions causing said at least one data processing device to quantify performance of each one of said investment choices by determining a composite investment performance score for each one of said investment choices and comparing the composite investment performance score of at least a portion of said investment choices, wherein determining the composite investment performance score for each one of said investment choices includes providing a weighting structure including a plurality of performance criteria and a plurality of performance factors selected to provide the desired investment effect, providing a relative weighting value for each one of said performance criteria and for each one of said performance factors selected to provide the desired investment effect, providing a performance factor value corresponding to each one of said performance factors for each one of said investment choices, deriving a score for each one of said performance factors using the corresponding one of said investment performance factor values and the corresponding relative weighting value, and deriving the composite investment performance score for each one of said investment choices from said investment performance factor scores thereof and the corresponding relative weighting value for each one of said performance criteria and wherein a first group of said performance factors subtends from a first one of said performance criteria, a second group of performance factors subtends from a second one of said performance criteria and at least one of said performance factors is a time-based measurement of at least one of said performance criteria.

2. The method of claim 1 wherein the plurality of performance criteria comprises a first performance criteria associated with risk of said investment choices and a second performance criteria associated with return of said investment choices.

3. The method of claim 1 wherein the plurality of performance criteria includes at least one of a performance criteria associated with risk of said investment choices and a performance criteria associated with return of said investment choices.

4. The method of claim 3 wherein the plurality of performance criteria includes at least one performance criteria not associated with risk or return of said investment choices.

5. The method of claim 1 wherein the model portfolio includes investments selected from within a single asset class.

6. The method of claim 1 wherein the plurality of performance criteria includes at least one performance criteria not associated with risk or return of said investment choices.

7. The method of claim 1 wherein comparing the composite investment performance score of at least a portion of said investment choices includes ranking at least a portion of said investment choices.

8. A system for facilitating management of a retirement savings plan, comprising:
at least one data processing device;
instructions processable by said at least one data processing device; and
an apparatus from which said instructions are accessible by said at least one data processing device;
wherein said instructions are configured for causing said at least one data processing device to:
provide a model portfolio for a participant of a retirement savings plan, wherein the model portfolio includes to investments within at least one asset class and wherein said at least one asset class is selected for providing a desired investment effect by the participant for the savings plan;
provide a plurality of available investment choices for said at least one asset class; and
quantify performance of each one of said investment choices by determining a composite investment performance score for each one of said investment choices and comparing the composite investment performance score of at least a portion of said investment choices, wherein determining the composite investment performance score for each one of said investment choices includes providing a weighting structure including a plurality of performance criteria and a plurality of performance factors selected to provide the desired investment effect, providing a relative weighting value for each one of said performance criteria and for each one of said performance factors selected to provide the desired investment effect, providing a performance factor value corresponding to each one of said performance factors for each one of said investment choices, deriving a score for each one of said performance factors using the corresponding one of said investment performance factor values and the corresponding relative weighting value, and deriving the composite investment performance score for each one of said investment choices from said investment performance factor scores thereof and the corresponding relative weighting value for each one of said performance criteria and wherein a first group of said performance factors subtends from a first one of said performance criteria, a second group of performance factors subtends from a second one of said performance criteria and at least one of said performance factors is a time-based measurement of at least one of said performance criteria.

9. The system of claim 8 wherein the plurality of performance criteria comprises a first performance criteria associated with risk of said investment choices and a second performance criteria associated with return of said investment choices.

10. The system of claim 8 wherein the plurality of performance criteria includes at least one of a performance criteria associated with risk of said investment choices and a performance criteria associated with return of said investment choices.

11. The system of claim 10 wherein the plurality of performance criteria includes at least one performance criteria not associated with risk or return of said investment choices.

12. The system of claim 8 wherein the model portfolio includes investments selected from within a single asset class.

13. The system of claim 8 wherein the plurality of performance criteria includes at least one performance criteria not associated with risk or return of said investment choices.

14. The system of claim 8 wherein comparing the composite investment performance score of at least a portion of said investment choices includes ranking at least a portion of said investment choices.

15. A computer-readable medium having tangibly embodied thereon and accessible therefrom a set of instructions interpretable by at least one data processing device, said set of instructions configured for causing said at least one data processing device to carry out operations for:
providing a model portfolio for a participant of a retirement savings plan, wherein the model portfolio includes investments within at least one asset class and wherein said at least one asset class is selected for providing a desired investment effect by the participant for the savings plan;
providing a plurality of available investment choices for said at least one asset class; and
quantifying performance of each one of said investment choices by determining a composite investment performance score for each one of said investment choices and comparing the composite investment performance score of at least a portion of said investment choices, wherein determining the composite investment performance score for each one of said investment choices includes providing a weighting structure including a plurality of performance criteria and a plurality of performance factors selected to provide the desired investment effect, providing a relative weighting value for each one of said performance criteria and for each one of said performance factors selected to provide the desired investment effect, providing a performance factor value corresponding to each one of said performance factors for each one of said investment choices, deriving a score for each one of said performance factors using the corresponding one of said investment performance factor values and the corresponding relative weighting value, and deriving the composite investment performance score for each one of said investment choices from said investment performance factor scores thereof and the corresponding relative weighting value for each one of said performance criteria and wherein a first group of said performance factors subtends from a first one of said performance criteria, a second group of performance factors subtends from a second one of said performance criteria and at least one of said performance factors is a time-based measurement of at least one of said performance criteria.

16. The computer-readable medium of claim 15 wherein the plurality of performance criteria comprises a first performance criteria associated with risk of said investment choices and a second performance criteria associated with return of said investment choices.

17. The computer-readable medium of claim 15 wherein the plurality of performance criteria includes at least one of a performance criteria associated with risk of said investment choices and a performance criteria associated with return of said investment choices.

18. The computer-readable medium of claim 17 wherein the plurality of performance criteria includes at least one performance criteria not associated with risk or return of said investment choices.

19. The computer-readable medium of claim 15 wherein the model portfolio includes investments selected from within a single asset class.

20. The computer-readable medium of claim 15 wherein the plurality of performance criteria includes at least one performance criteria not associated with risk or return of said investment choices.
